(19) United States
(12) Patent Application Publication
(10) Pub. No.: US 2010/0072733 A1
(43) Pub. Date: Mar. 25, 2010

(54) Vehicle conversion

(76) Inventor: Avraham Levi, Moshav Beit Halevi (IL)

Correspondence Address: EITAN MEHULAL LAW GROUP, 10 Abba Eban Blvd. PO Box 2081, Herzlia, 46120, IL

(21) Appl. No.: 12/585,365

(22) Filed: Sep. 14, 2009

Related U.S. Application Data
(60) Provisional application No. 61/136,637, filed on Sep. 22, 2008.

(51) Int. Cl. B60G 5/00; B23P 23/00

(52) U.S. Cl. 280/682; 29/401.1

(57) ABSTRACT

Vehicle conversion; for example, a vehicle conversion kit to convert a vehicle from a first vehicular type into a second, different, vehicular type. The vehicle conversion kit includes: an intermediary sub-chassis unit adapted for attachment to a chassis of the vehicle; a first tandem suspension adapted to pivotally connect to a right side of the intermediary sub-chassis unit; and a second tandem suspension adapted to pivotally connect to a left side of the intermediary sub-chassis unit, wherein the first and second tandem suspensions comprise first and second ground directing units, respectively; and wherein each one of the first and second tandem suspensions is adapted for suspension from the intermediary sub-chassis unit through a shock absorbing unit.

### PRIOR APPLICATION DATA

This application claims priority and benefit from U.S. Provisional Patent Application No. 61/136,637, titled “Vehicle Conversion”, filed on Sep. 22, 2008, which is hereby incorporated by reference in its entirety.

### FIELD

Some embodiments are related to the field of vehicles.

### BACKGROUND

U.S. Pat. No. 5,482,326, which is hereby incorporated by reference in its entirety, discloses an apparatus providing a pivot axis to rear wheels of a vehicle. The apparatus includes an arm pivotally attached to the chassis, a rocking member, and a ground directing unit. The rocking member is pivotally attached to the arm at a central location on the rocking member and rotatably connected to one forward and one rearward wheel at front and back locations, respectively, of the rocking member. The ground directing unit is pivotally attached to the arm (or to an extension thereof) and to the rocking member near the rearward wheel. This arrangement, as U.S. Pat. No. 5,482,326 discloses, provides a force to the rearward wheel while no force is provided to the forward wheel and thus, provides a rear pivot axis to the vehicle.

### SUMMARY

There is provided, according to some embodiments, a vehicle conversion kit comprising an intermediary unit adapted for attachment to a chassis of the vehicle; and a pair of tandem suspensions, each comprising a ground directing unit, wherein each of said tandem suspensions is adapted for suspension from said intermediary unit by a shock absorbing unit and adapted for pivotal connection to said intermediary unit.

In some embodiments, each of said tandem suspensions further comprises a drive mechanism adapted to relay rotational power from a rotatable axle of the vehicle to two wheels of said tandem suspension.

There is further provided, according to an embodiment, a method for converting a vehicle, the method comprising: attaching an intermediary unit to a chassis of the original vehicle; and attaching a pair of tandem suspensions, each comprising a ground directing unit to the intermediary unit, wherein each of the tandem suspensions is suspended from the intermediary unit by a shock absorbing unit and is pivotally connected to the intermediary unit.

In some embodiments, the method further comprises connecting a drive mechanism of each of the tandem suspensions to a rotatable axle of the vehicle.

There is further provided, according to an embodiment, a converted vehicle comprising an intermediary unit attached to a chassis of the vehicle; and a pair of tandem suspensions, each comprising a ground directing unit, wherein each of said tandem suspensions is suspended from said intermediary unit by a shock absorbing unit and pivotally connected to said intermediary unit.

In some embodiments, each of said tandem suspensions further comprises a drive mechanism adapted to relay rotational power from a rotatable axle of the vehicle to two wheels of said tandem suspension.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. It is intended that the embodiments and figures disclosed herein are to be considered illustrative rather than restrictive. The figures are listed below.

FIG. 1 shows an exploded view of a vehicle conversion kit;

FIG. 2 shows a perspective view of an assembled vehicle conversion kit;

FIG. 3A shows a side view of a tandem suspension on level ground;

FIG. 3B shows a side view of a tandem suspension near an obstacle;

FIG. 3C shows a side view of a tandem suspension near a hole;

FIG. 4 shows a top view of a rocking member of a tandem suspension;

FIG. 5 shows a side view of a tandem suspension with a drive mechanism;

FIG. 6 shows a top view of a tandem suspension with a drive mechanism;

FIG. 7 shows a side view of an exemplary converted Hummer vehicle;

FIG. 8 shows an enlarged side view of an exemplary converted Hummer vehicle;

FIG. 9 shows an exemplary converted Hummer vehicle climbing an obstacle;

FIG. 10 shows an exemplary converted Hummer vehicle entering a hole;

FIG. 11 shows an exemplary converted Hummer vehicle finishing a climb over an obstacle;

FIG. 12 shows a sub-chassis being laid over a chassis of an exemplary Hummer vehicle;

FIG. 13 shows another view of a sub-chassis being laid over a chassis of an exemplary Hummer vehicle;

FIGS. 14-18 show various views of an exemplary converted Hummer vehicle;

FIG. 19 shows an exemplary converted Hummer vehicle climbing an obstacle;

FIG. 20 shows a perspective view of a vehicle conversion kit assembled on a chassis;

FIG. 21 shows a perspective view of an assembled vehicle conversion kit;

FIG. 22 shows an exploded view of a vehicle conversion kit;

FIG. 23 shows a perspective view of a vehicle conversion kit assembled on a chassis; and

FIG. 24 shows a flow chart of a method for converting a vehicle.

### DETAILED DESCRIPTION

An aspect of some embodiments relates to a kit and a method for converting a vehicle from one having two rear wheels (or four rear wheels in which each pair is fixed together and cannot pivot), into a vehicle having four rear wheels, wherein each lateral pair of wheels is adapted to pivot around an axis.

In some embodiments, the conversion kit includes two tandem suspensions, one for each side of the vehicle. Each of the tandem suspensions may enable the assembly of two wheels upon it, the two wheels being adapted to pivot around an axis of the tandem suspension. If the vehicle is equipped with a rear wheel drive, the tandem suspensions may each be powered through a rotatable axle connected to the differential of the vehicle, thereby transmitting power to both of the tandem suspension's two wheels.

In some embodiments, the conversion may enhance one or more of the vehicle's capabilities, such as:
The vehicle's breakover angle: a measurement of its ability to drive over a sharp ridge without touching its underside. The conversion may decrease the vehicle's wheelbase, thereby increasing its breakover angle.
The vehicle's obstacle climbing ability.
The vehicle's performance in long and slow climbing.
The vehicle's load carrying.
The vehicle's cargo platform size.
The vehicle's departure angle: a measurement of its ability to depart a steep incline and exit off of rocks or other obstacles without touching the rear bumper. The conversion may bring the rearmost wheels closer to the vehicle's rear bumper, thereby increasing its departure angle.
The vehicle's suspension travel: The maximum length to which the suspension can extend when the vehicle departs the ground.
The vehicle's turning radius.
The travel comfort provided by the vehicle.

In some embodiments, the conversion may be performed essentially without structural changes to the vehicle's existing chassis. Hence, if it is desired to revert to the vehicle's original configuration, removal of the conversion kit and restoration of the original configuration is relatively easy and cost-effective to perform.

In addition, in some embodiments, the conversion of the vehicle using the kit may be performed in a relatively short time and using essentially simple means.

### Conversion Kit

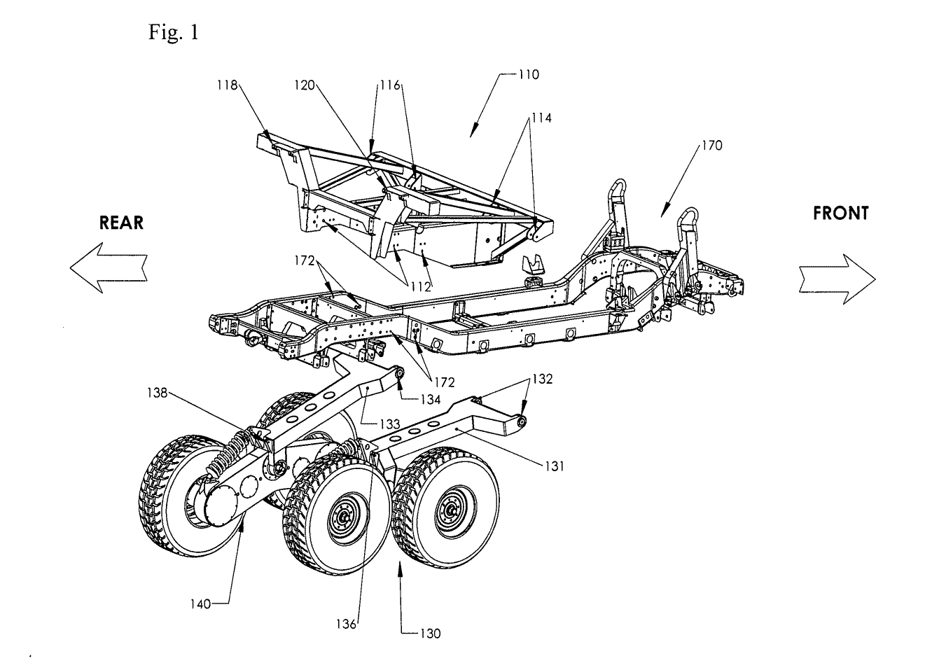

Reference is now made to FIG. 1, which shows an exploded view of a conversion kit including an intermediary unit, such as sub-chassis 110, and two tandem suspensions 130 and 140, along with a chassis 170 of a vehicle to be converted. Chassis 170 shown in the figure is that of a General Motors' Hummer, an off-road vehicle whose original configuration includes four wheels (of which two are in the front and two are in the rear) and thus, its converted form would have six wheels. Likewise, the kit and method of the present disclosure may apply to any other type of vehicle originally having two rear wheels, and hence, all these types are explicitly intended herein. The Hummer example is given for reasons of simplicity only.

Sub-chassis 110 may serve as an intermediary unit for essentially attaching tandem suspensions 130 and 140 to chassis 170 at its rear part, which may lack, in some scenarios, sufficient anchoring points for direct attachment of the tandem suspensions. Sub-chassis 110 is optionally made of metal. Sub-chassis 110 may include screw holes 112 and/or other screw holes that are not shown, for attachment to chassis 170 via matching screw holes 172 and/or other screw holes that are not shown but exist in the chassis.

Sub-chassis 110 may further include anchoring points 114 and 116 for pivotally attaching arms 131 and 133 of tandem suspensions 130 and 140, respectively, via respective connectors 132 and 134 in the arms.

Additionally, sub-chassis 110 may include shock absorbing unit connectors 118 and 120 for connecting one or more shock absorbing units (not shown) to each of tandem suspensions 130 and 140, respectively, via matching shock absorbing unit connectors 136 and 138 in the tandem suspensions.

Other than screw holes 112, anchoring points 114 and 116 and shock absorbing unit connectors 118 and 120, sub-chassis 110 is shown having other, non-referenced parts, such as parts adapted for support and/or matching of the structure of chassis 170. Some or all of these non-referenced parts, as well as screw holes 112, anchoring points 114 and 116 and shock absorbing unit connectors 118 and 120, may be structured differently in other embodiments (not shown) suited for different vehicles. For example, different vehicles may have a differently-structured chassis requiring a different, matching sub-chassis, and/or may include a rear cargo platform or cabin installed over the sub-chassis and therefore requires fitting. For simplicity of presentation, sub-chassis 110 is shown having a structure matching chassis 170 of an exemplary Hummer vehicle and a cargo platform (not shown) of that vehicle.

Similar to FIG. 1, FIG. 22 shows a semi-pictorial exploded view of a vehicle conversion kit, including a sub-chassis, a rollover bar and two tandem suspensions, with the vehicle's chassis in between the sub-chassis and the tandem suspensions.

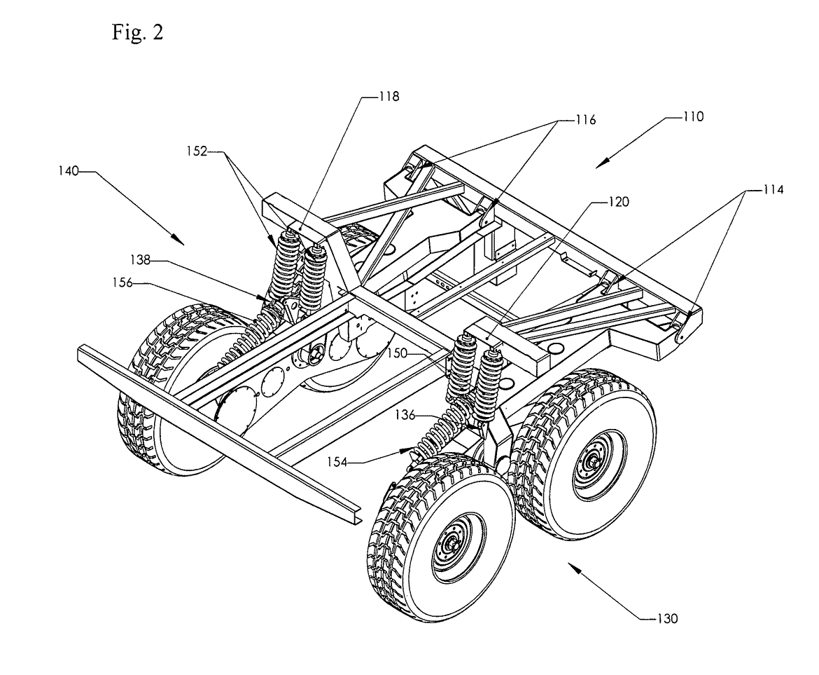

Reference is now made to FIG. 2, which shows a perspective view of a vehicle conversion kit 200, the same as the kit of FIG. 1, but shown here in its assembled form. For simplicity of presentation, kit 200 is shown assembled as-is, without its mounting on a vehicle's chassis. Shown in this figure, in addition to what is shown in FIG. 1, is shock absorbing units 150 and 152, each including two shock absorbing units. In other embodiments (not shown), each of the shock absorbing units includes a single unit or more than two units.

Each of shock absorbing units 150 and 152 is shown connected to its respective shock absorbing unit connector 114 or 116 on one side, and to its matching shock absorbing unit connector 136 or 138 in the tandem suspensions on the other side.

Ground directing units 154 and 156 are also shown in this figure, and are discussed in greater detail below.

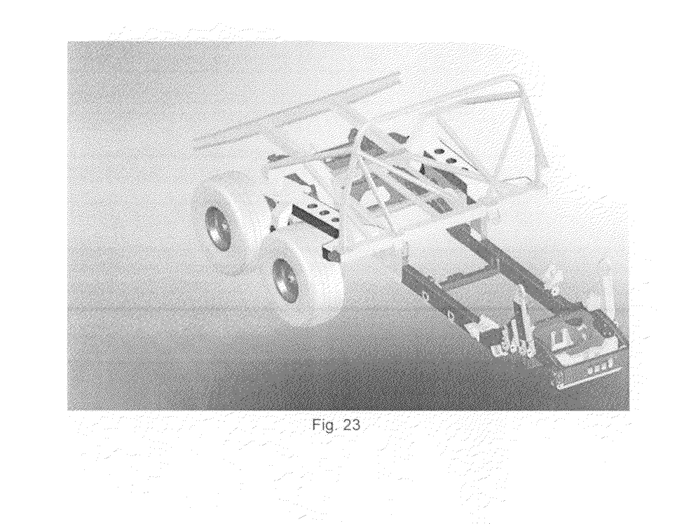

As in FIG. 2, FIG. 20 shows a semi-pictorial perspective view of a vehicle conversion kit assembled on a chassis, including a rollover bar installed on the sub-chassis. Similarly, FIG. 23 shows a semi-pictorial perspective view of a vehicle conversion kit assembled on a chassis.

### Tandem Suspensions

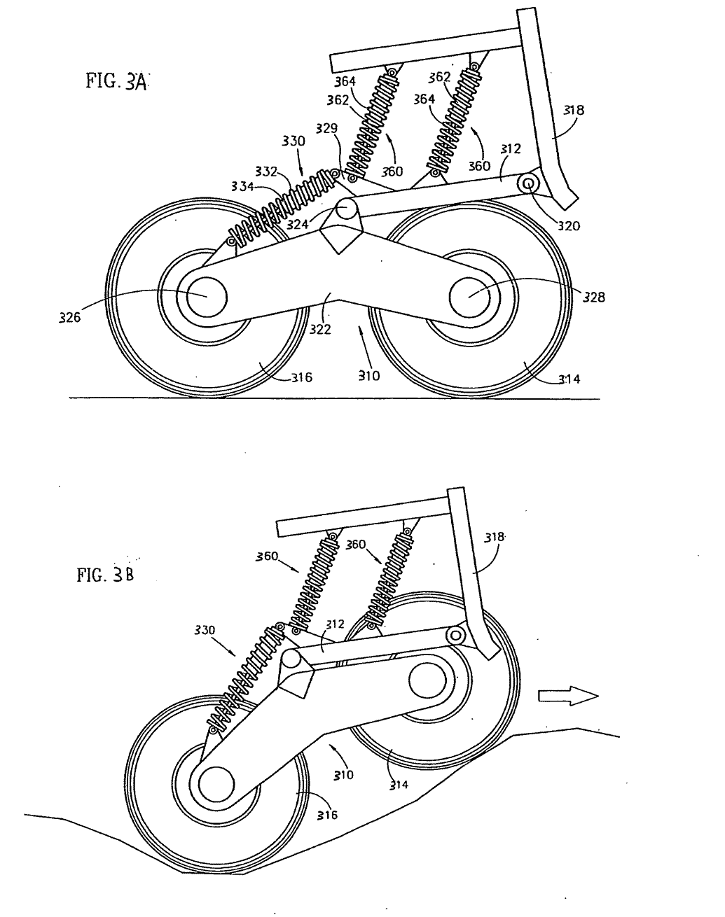

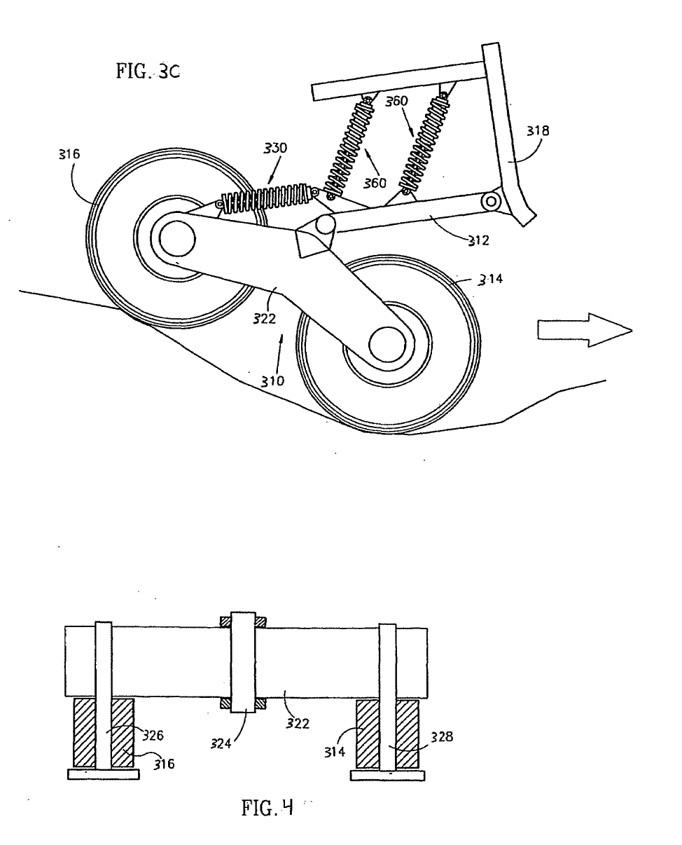

Reference is now made to FIGS. 3A, 3B and 3C which show, in greater detail, a tandem suspension according to an embodiment. Each tandem suspension is adapted to provide a pivot axis to two wheels assembled on it, thereby providing the vehicle with enhanced capabilities.

FIGS. 3A, 3B and 3C are side views and illustrate the vehicle in three states, that of level ground, near an obstacle and near a hole, respectively. References also made to FIG. 4 which is a top view of a rocking member forming part of the tandem suspension.

Tandem suspension 310 is operative to provide a rear pivot axis to the vehicle. As mentioned, during the conversion of the vehicle, one tandem suspension is provided in each side of the vehicle's rear part. Tandem suspension 310 utilizes an arm 312 and connects it to a forward and a rearward set of wheels 314 and 316, respectively. Arm 312 is pivotally attached to sub-chassis 318 via hinge 320.

A rocking member 322 is pivotally attached to arm 312 via axis 324. Forward and rearward wheels 314 and 316 are attached to rocking member 322 via axes 326 and 328 (FIG. 4).

Tandem suspension 310 additionally comprises a ground directing unit 330, which is pivotally connected to an extension 329 of arm 312, and to the rocking member 322 near the axis 326 of the rear wheel 316. Unit 330, typically comprising a spring 332 and a damper 334, provides a downward force to its corresponding rearward wheel 316.

Therefore, when the forward wheels 314 rise to travel over an obstacle (FIG. 3B), the springs 332 of units 330 push the rearward wheels 316 downwards and the rocking members 322 rotate about the axis 324. When the forward wheels 314 fall forward, such as occurs when falling in a hole (FIG. 3C), the rocking members 322 rotate once again and the rearward wheels 316 rise until the damper 334 is fully compressed.

Thus, in both situations, since units 330 act only on the rearward wheels 316, they force the axis 328 of rearward wheels 316 to become a pivot axis, about which the vehicle can rise and fall.

As the wheels 314 and 316 rise and fall, the arms 312 pivot about hinge 320 with respect to the sub-chassis 318 and, accordingly, with respect to the vehicle's chassis (not shown). Shock absorbing units 360 are shown in a configuration different than the one shown in the embodiment of FIG. 2. While in FIG. 2 each of shock absorbing units 118 and 120 are placed side-by-side, shock absorbing units 360 are placed one after the other. Each of these two possible embodiments is intended to provide shock absorption between the tandem suspension and the sub-chassis (and, consecutively, the vehicle's chassis). In other embodiments (not shown), two shock absorbing units per side may be positioned differently than what is shown in FIGS. 2 and 3A-C. In yet further embodiments (not shown), only one shock absorbing unit per side exists, or, alternatively, more than two units per side are used—such as three or more units per side.

Generally, shock absorbing units 360, which are pivotally connected between the arms 316 and the sub-chassis 318, minimize the rotation between the arms 316 and the sub-chassis 318. If desired, the rear shock absorbing unit 360 can be connected to extension 329 of arm 312. Shock absorbing unit 360 optionally includes a spring 364 and a damper 362, similar to ground directing unit 330. Alternatively, shock absorbing unit 360 may be different than ground directing unit 330.

Should both sets of wheels 314 and 316 become airborne, spring 332 of unit 330 extends, causing the rearward wheels 316 to be extending. Thus, upon landing, rearward wheels 316 touch first and dampers 334 absorb some of the landing force. Afterwards, forward wheels 314 land and shock absorbing units 360 aid in absorbing the remaining landing force.

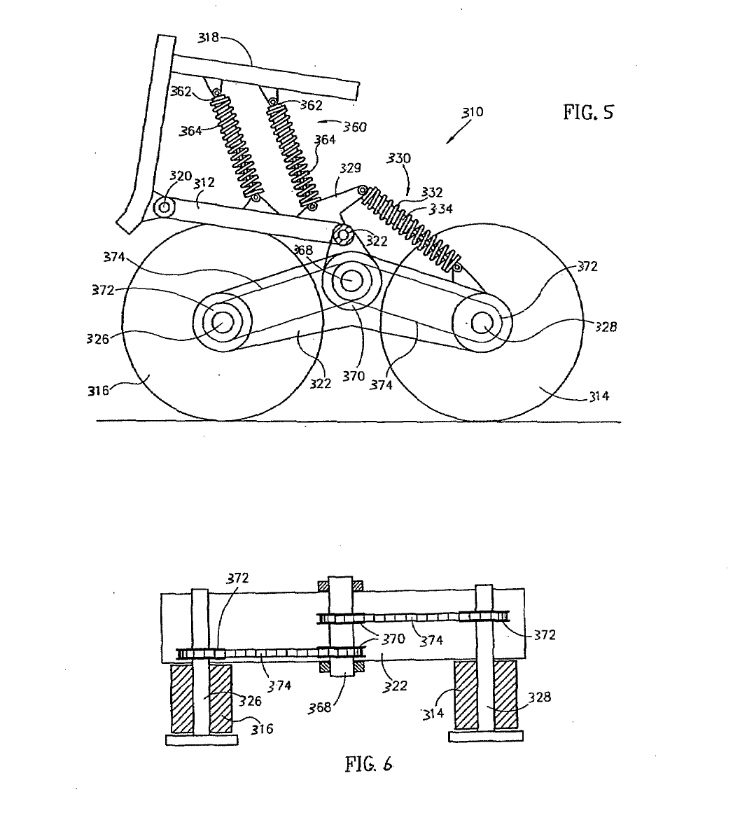

Reference is now made to FIGS. 5 and 6, which illustrate an embodiment for use in vehicles with rear wheel drive. This embodiment includes a drive mechanism in addition to the other elements of the apparatus for providing a pivot axis.

The embodiment of FIGS. 5 and 6 additionally comprises an axis 368 driven by the differential (not shown) of the vehicle through the vehicle's rear axle (not shown) and located within rocking member 322 near axis 324, two drive wars 370 rotated by the axis 368, two follower gears 372, one per wheel, and two timing belts 374. Timing belts 374 connect between their respective drive gears 370 and follower gears 372.

As shown in FIG. 5, drive gear 370 is higher above the ground, labeled 328, than follower gears 372, thereby ensuring that no portion of chassis 314 touches the ground.

### Exemplary Converted Vehicle

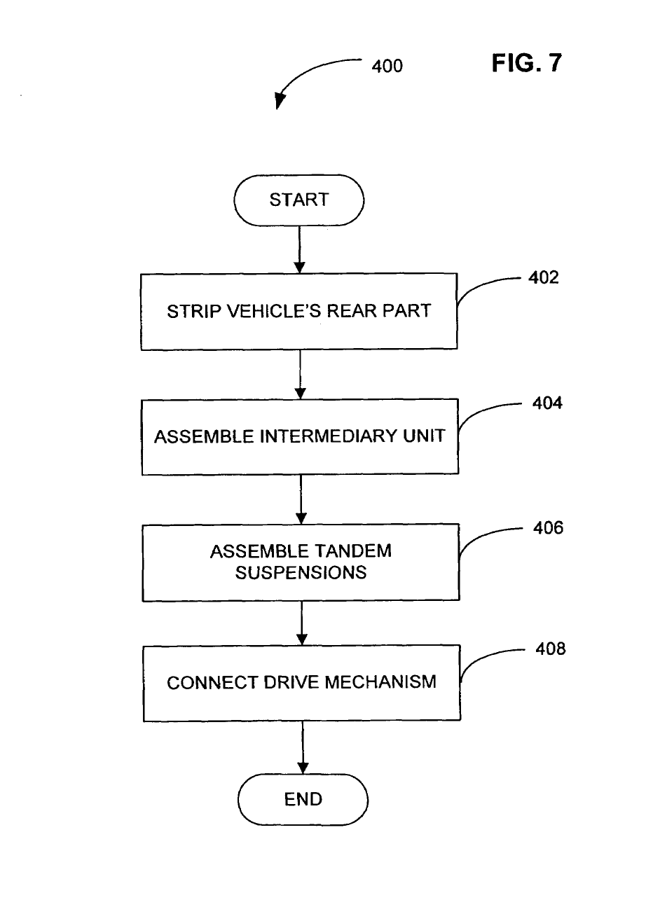

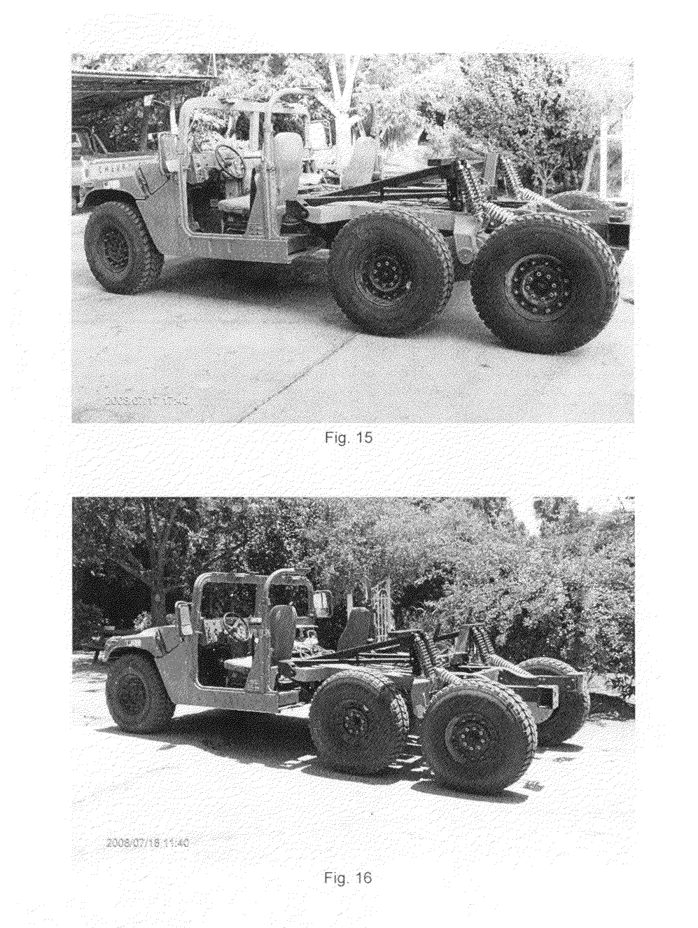

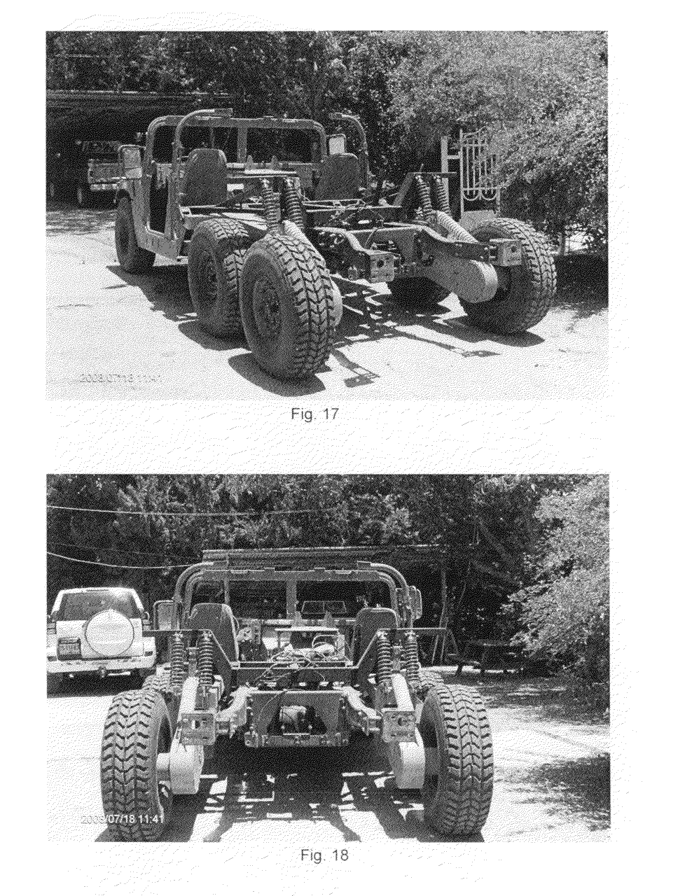

Reference is now made to FIGS. 7-19, which show an exemplary Hummer vehicle being converted, as well as the vehicle in its final, converted form.

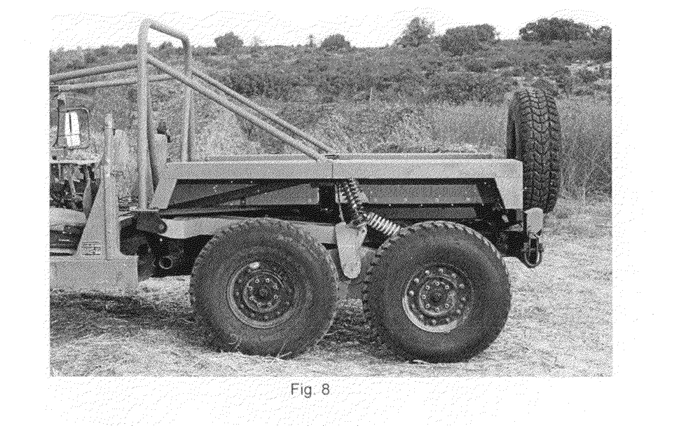

FIG. 7 shows a side view of the vehicle and FIG. 8 shows a similar enlarged view. On each side of the vehicle, a tandem suspension with two wheels is shown, connected to a sub-chassis. The vehicle's original cargo platform is shown assembled over the sub-chassis.

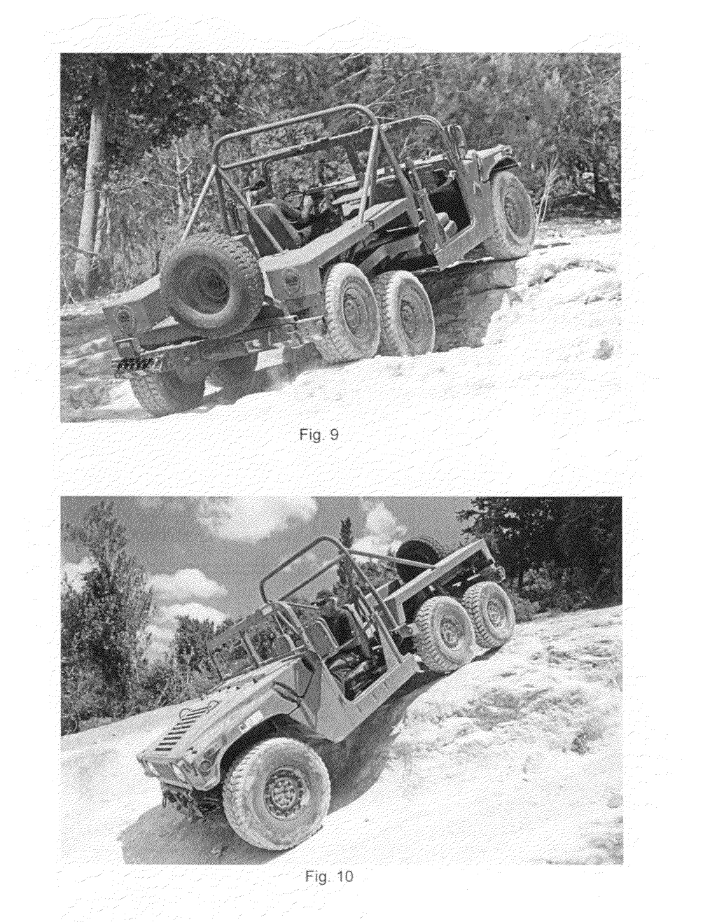

FIG. 9 shows the vehicle climbing an obstacle. The forward wheels of each of the tandem suspensions are shown farther away from the vehicle than the rearward wheels, due to the axial characteristics of the tandem suspensions and the vehicle's posture.

FIG. 10 shows the vehicle entering a hole. The rearward wheels of each of the tandem suspensions are shown farther away from the vehicle than the forward wheels, due to the ground directing units of the tandem suspensions and the vehicle's posture.

FIG. 11 shows the vehicle finishing a climb over an obstacle. The rearward wheels of each of the tandem suspensions are shown airborne, and the rear part of the vehicle is supported by the forward wheels of the tandem suspensions.

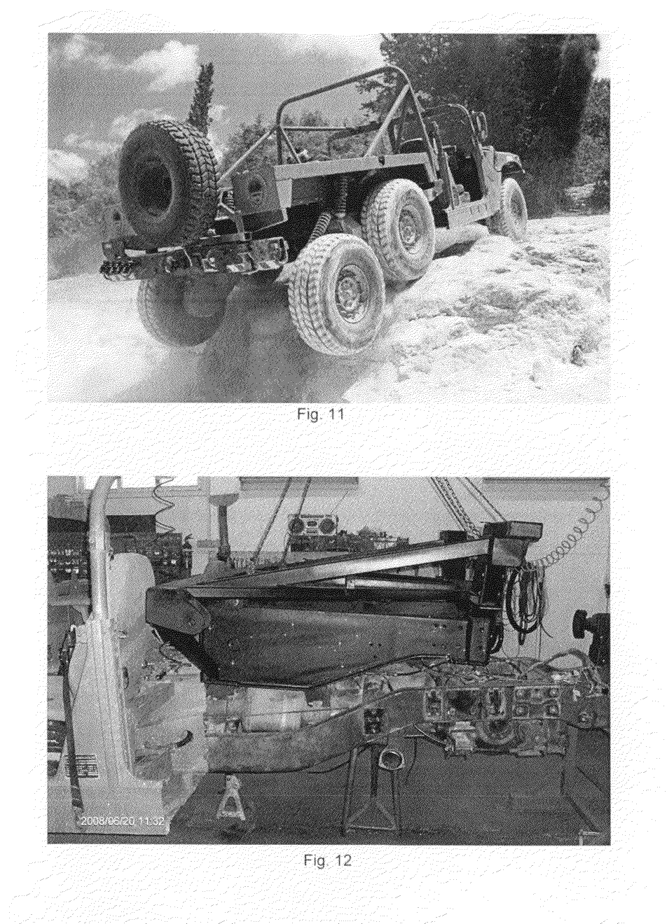

FIG. 12 shows a sub-chassis being laid over a chassis of an exemplary Hummer vehicle, prior to being connected with screws to the chassis.

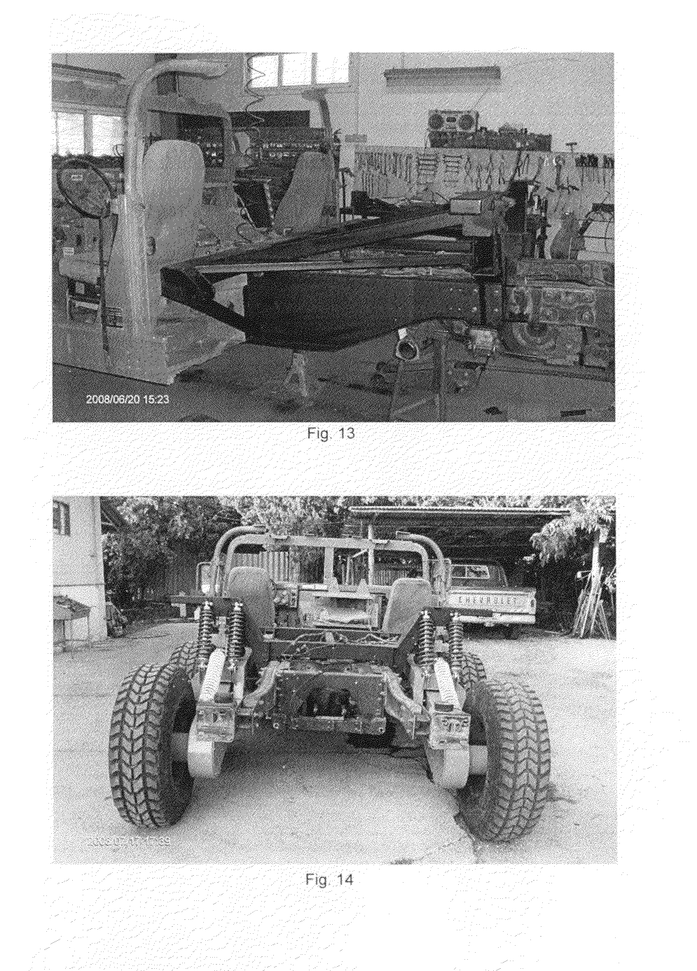

FIG. 13 shows the sub-chassis being fully positioned on the chassis and ready to being connected using the screws.

FIGS. 14-18 show various views of an exemplary converted Hummer vehicle, without any cargo platform, cabin or the like installed over the sub-chassis. Various elements of the conversion kit, such as the tandem suspensions and the sub-chassis are visible in these figures.

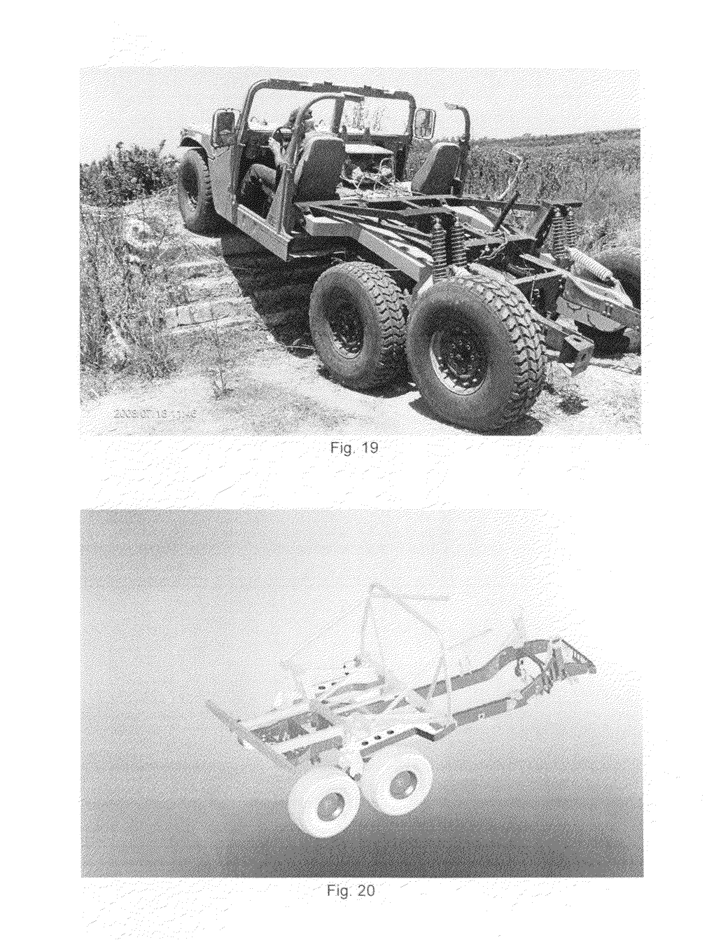

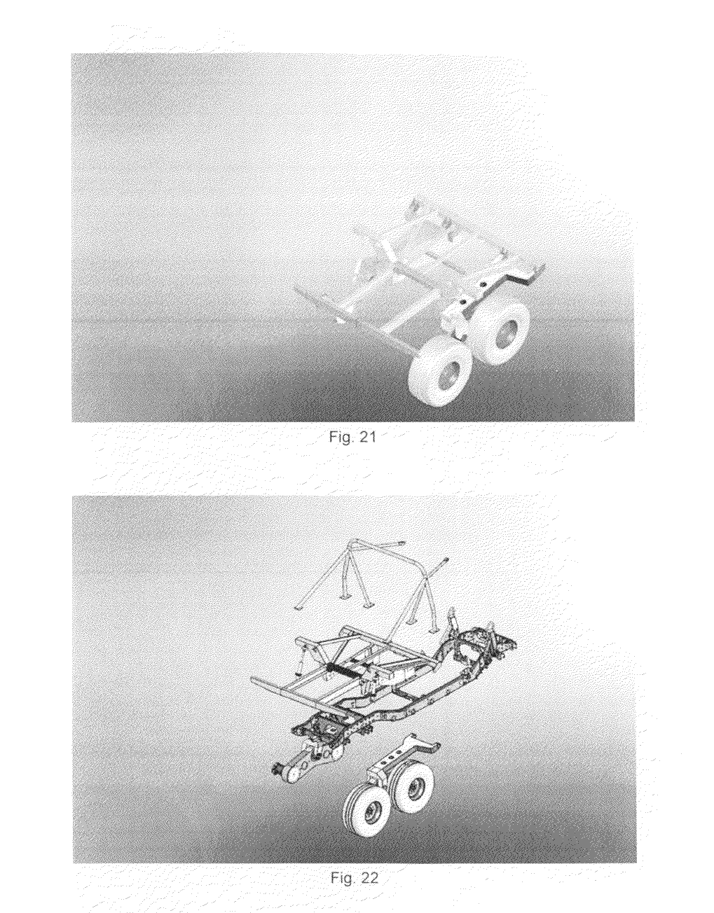

FIG. 19 shows the vehicle climbing an obstacle.

### Method for Converting a Vehicle

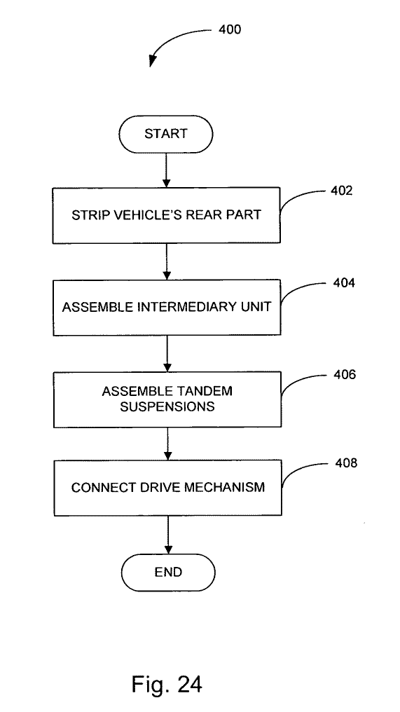

Reference is now made to FIG. 24, which shows a flow chart of a method 400 for converting a vehicle into a vehicle having four rear wheels, wherein each lateral pair of wheels is adapted to pivot around an axis.

In a block 402, the rear part of the vehicle is stripped essentially down to the chassis. For example, a cargo platform or a rear cabin may be removed from the chassis at this stage. The rear wheels and their suspensions and bearings may also be removed.

In a block 404, an intermediary unit, such as a sub-chassis, is attached to a chassis of the original vehicle, as shown in FIGS. 12-13. The attachment is optionally performed by threading screws through matching holes in the sub-chassis and the chassis. Optionally, no holes are drilled in the chassis, and the chassis existing screw holes are used for this attachment.

In a block 406, a pair of tandem suspensions, each including a ground directing unit, is attached to the intermediary unit. Alternatively, the ground directing unit may be assembled on their respective tandem suspensions at a later time. The attachment of the pair of tandem suspensions to the intermediary unit is performed so that an arm of each of the tandem suspensions is pivotally connected to the intermediary unit.

In addition, at least one shock absorbing unit is connected to each of the tandem suspensions on one side and to the intermediary unit on the other side.

In a block 408, if the vehicle includes a rear drive, as in many off-road vehicles and trucks, the vehicle's rear axle, which is adapted to receive rotary power from the differential, is connected to a drive mechanism of each of the tandem suspensions.

In addition to the steps of method 400 described above, method 400 may include additional one or more steps for mounting additional feature(s) onto the vehicle. For example, a cargo platform, a rear cabin and/or a rollover bar may be mounted over the sub-chassis.

Some embodiments may allow converting, for example, a four-by-four vehicle into a six-by-six vehicle, using screwing mechanisms exclusively and without the need for welding or soldering the original chassis of the vehicle, and without modifying the original systems of the vehicle.

While a number of exemplary aspects and embodiments have been discussed above, those of skill in the art will recognize certain modifications, permutations, additions and sub-combinations thereof. It is, therefore, intended that the following claims and claims hereafter introduced be interpreted to include all such modifications, permutations, additions and sub-combinations as are within their true spirit and scope.

What is claimed is:

1. An apparatus comprising:
a vehicle conversion kit to convert a vehicle from a first vehicular type into a second, different, vehicular type,
wherein the vehicle conversion kit comprises:
an intermediary sub-chassis unit adapted for attachment to a chassis of the vehicle;
a first tandem suspension adapted to pivotally connect to a right side of the intermediary sub-chassis unit; and
a second tandem suspension adapted to pivotally connect to a left side of the intermediary sub-chassis unit,
wherein the first and second tandem suspensions comprise first and second ground directing units, respectively,
wherein each one of the first and second tandem suspensions is adapted for suspension from the intermediary sub-chassis unit through a shock absorbing unit.

2. The apparatus of claim 1, further comprising:
a first set of two wheels assembled upon the first tandem suspension and adapted to pivot around a first axis of the first tandem suspension; and
a second set of two wheels assembled upon the second tandem suspension and adapted to pivot around a second axis of the second tandem suspension.

3. The apparatus of claim 2, wherein the first tandem suspension comprises a first drive mechanism adapted to relay rotational power from a rotatable axle of the vehicle to the set of two wheels of the first tandem suspension,
wherein the second tandem suspension comprises a second drive mechanism adapted to relay rotational power from said rotatable axle of the vehicle to the set of two wheels of the second tandem suspension.

4. The apparatus of claim 3, wherein the vehicle comprises a rear wheel drive,
wherein the first tandem suspension is powered through a first rotatable axle connected to a differential of the vehicle and adapted to transmit power to the set of two wheels of the first tandem suspension,
wherein the second tandem suspension is powered through a second rotatable axle connected to the differential of the vehicle and adapted to transmit power to the set of two wheels of the second tandem suspension.

5. The apparatus of claim 1, wherein the first set of wheels comprises a forward wheel and a rearward wheel connected to an arm of the first tandem suspension,
wherein the arm is pivotally connected to the intermediary sub-chassis unit,
wherein a rocking member is pivotally attached via an axis to said arm and is further attached to the forward wheel and the rearward wheel.

6. The apparatus of claim 5, wherein the first ground directing unit is pivotally connected to the rocking member and to an extension of said arm in proximity to said rearward wheel.

7. The apparatus of claim 6, wherein the first ground directing unit comprises a spring and a damper, and wherein the first ground directing unit is to provide a downward force to said rearward wheel.

8. The apparatus of claim 7, wherein, upon rising of the forward wheel, the spring is to push the rearward wheel downward, and the rocking member is to rotate around said first axis.

9. The apparatus of claim 7, wherein, upon falling of the forward wheel, the rocking member is to rotate around said first axis.

10. The apparatus of claim 7, wherein, upon landing of the forward wheel and the rearward wheel from being airborne, the spring is to extend and the rearward wheel is to extend and touch ground prior to the forward wheel.

11. The apparatus of claim 2, wherein the vehicle conversion kit to convert the vehicle from having two rear wheels to having four rear wheels,
wherein the four rear wheels comprise:
said first pair of two wheels assembled upon the first tandem suspension and adapted to pivot around the first axis of the first tandem suspension; and
said second pair of two wheels assembled upon the second tandem suspension and adapted to pivot around the second axis of the second tandem suspension.

12. The apparatus of claim 2, wherein the vehicle conversion kit to convert the vehicle from having four non-pivoting rear wheels to having four pivoting rear wheels,
wherein the four pivoting rear wheels comprise:
said first pair of two wheels assembled upon the first tandem suspension and adapted to pivot around the first axis of the first tandem suspension; and
said second pair of two wheels assembled upon the second tandem suspension and adapted to pivot around the second axis of the second tandem suspension.

13. A vehicle comprising:
a chassis;
two front wheels attached to the chassis;
an intermediary sub-chassis unit adapted for attachment to the chassis;
a first tandem suspension adapted to pivotally connect to a right side of the intermediary sub-chassis unit; and
a second tandem suspension adapted to pivotally connect to a left side of the intermediary sub-chassis unit,
wherein the first and second tandem suspensions comprise first and second ground directing units, respectively,
wherein each one of the first and second tandem suspensions is adapted for suspension from the intermediary sub-chassis unit through a shock absorbing unit.

14. The vehicle of claim 13, further comprising:
a first set of two wheels assembled upon the first tandem suspension and adapted to pivot around a first axis of the first tandem suspension; and
a second set of two wheels assembled upon the second tandem suspension and adapted to pivot around a second axis of the second tandem suspension.

15. The vehicle of claim 14, wherein the first tandem suspension comprises a first drive mechanism adapted to relay rotational power from a rotatable axle of the vehicle to the set of two wheels of the first tandem suspension,
wherein the second tandem suspension comprises a second drive mechanism adapted to relay rotational power from said rotatable axle of the vehicle to the set of two wheels of the second tandem suspension.

16. The vehicle of claim 13, wherein the first set of wheels comprises a forward wheel and a rearward wheel connected to an arm of the first tandem suspension,
wherein the arm is pivotally connected to the intermediary sub-chassis unit,
wherein a rocking member is pivotally attached via an axis to said arm and is further attached to the forward wheel and the rearward wheel.

17. The vehicle of claim 16, wherein the first ground directing unit is pivotally connected to the rocking member and to an extension of said arm in proximity to said rearward wheel.

18. A method of converting a vehicle from a first vehicular type into a second, different, vehicular type, the method comprising:
attaching an intermediary sub-chassis unit to a chassis of the vehicle;
pivotally connecting a first tandem suspension to a right side of the intermediary sub-chassis unit;
pivotally connecting a second tandem suspension to a left side of the intermediary sub-chassis unit; and
providing, in the first and second tandem suspensions, first and second ground directing units, respectively,
wherein each one of the first and second tandem suspensions is adapted for suspension from the intermediary sub-chassis unit through a shock absorbing unit.

19. The method of claim 18, further comprising:
connecting a first set of two wheels upon the first tandem suspension to pivot around a first axis of the first tandem suspension; and
connecting a second set of two wheels upon the second tandem suspension to pivot around a second axis of the second tandem suspension.

20. The method of claim 19, wherein the first tandem suspension comprises a first drive mechanism adapted to relay rotational power from a rotatable axle of the vehicle to the set of two wheels of the first tandem suspension,
wherein the second tandem suspension comprises a second drive mechanism adapted to relay rotational power from said rotatable axle of the vehicle to the set of two wheels of the second tandem suspension.
